(19) United States
(12) Patent Application Publication
(10) Pub. No.: US 2025/0276390 A1
(43) Pub. Date: Sep. 4, 2025

(54) MILLING CUTTER BODY WITH INSERT WEDGES THREADINGLY ENGAGED TO FASTENERS HAVING TRANSVERSELY DIRECTED KEY RECESSES

(71) Applicant: ISCAR, LTD., TEFEN (IL)

(72) Inventor: GIL HECHT, NAHARIYA (IL)

(73) Assignee: ISCAR, LTD., TEFEN (IL)

(21) Appl. No.: 18/591,491

(22) Filed: Feb. 29, 2024

(51) Int. Cl. B23C 5/22

(52) U.S. Cl. CPC B23C 5/2265

(57) ABSTRACT

A rotatable milling cutter body has a plurality of insert seats, each communicating with a respective, rearwardly located fastener receptacle. An insert wedge occupying the insert seat and a fastener occupying the fastener receptacle are arranged along a common central fastener axis (S). The fastener has a threaded bore extending along a fastening axis (F) which is coincident with the central fastener axis (S). The fastening axis (F) defines a radial fastening direction (Rf) perpendicular thereto. Formed in a peripheral surface of the fastener is a key recess. The fastener is configured to rotate and threadingly engage a rearwardly directed threaded pin of the insert wedge, upon insertion of a key into the key recess in a direction parallel to the radial fastening direction (Rf), followed by movement of the key in a predetermined circumferential fastening direction about the corresponding central fastener axis (S).

### FIELD OF THE INVENTION

The subject matter of the present application relates to rotatable cutting tools having replaceable cutting inserts. Specifically, the subject matter of the present application relates to milling cutters for metal machining.

### BACKGROUND OF THE INVENTION

Milling cutters are rotated during machining operations in order to remove material from the workpiece being machined. Ordinarily, milling cutters are designed with a coupling portion and a cutting portion. The coupling portion ensures repeatable conditions in the location of the milling cutters during machining operations. Similarly, this ensures a repeatable overhang of the milling tool. The greater the overhang is, the more compromised the cutting conditions may be, due to vibrations and inaccuracies in the location of the milling cutters. The present application is directed mainly to milling cutters which include cutting inserts which are made of material presenting difficulties in a bore extending through said cutting inserts. Such material may be, for instance, a ceramic material. Such inserts present difficulties in common fasteners, e.g. a screw passing through a bore located in an insert and clamping said insert.

Typically, each cutting insert is secured by a clamp mechanism which wedges the cutting inserts, e.g., see US2015273589, US2007245535.

In some cases, it is preferred that the clamping mechanism is actuated from a location removed from the cutting inserts. This is done, for example, due to adverse effects of the machining operation on the actuation of the clamping mechanism (such as metal chips clogging the mechanism). Such a mechanism can be seen in WO2023058593.

An example of a milling cutter with a side-actuated screw is disclosed in US2009297282, US2019118272, US2018111206. Notably, this mechanism is not a clamping mechanism, rather it is an adjustment mechanism, used in controlling the positioning of the cutting insert along one axis.

It is an object of the subject matter of the present application to provide an improved tool and cutter for clamping cutting inserts lacking a clamping bore.

### SUMMARY OF THE INVENTION

In accordance with a first aspect of the subject matter of the present application there is provided an insert holder rotatable about a central axis C defining a radial direction Rd perpendicular to the central axis C and opposing forward and rearward directions Df, Dr, the insert holder comprising:
a coupling portion and a cutting portion located forwardly of the coupling portion, the cutting portion comprising:
a forward end surface facing, and delimiting the insert holder, in the forward direction Df;
a holder peripheral surface extending between the forward end surface and the coupling portion;
a plurality of insert seats, each comprising a seating surface and opening out to at least one of the forward end surface and the holder peripheral surface;
a plurality of insert wedges, each located at least partially in a respective insert seat; and
a plurality of fasteners, each located rearwardly of, and coupled to, a respective insert wedge;
wherein:
each fastener is centered about a corresponding fastening axis F and its respective insert wedge extends along the corresponding fastening axis F; and
each fastener is configured to be actuated from a radial fastening direction Rf perpendicular to the corresponding fastening axis F.

The present invention allows for fast and easy removal of cutting inserts from the insert holder while maintaining the advantage of actuating the insert fastening mechanisms at a location away from the insert seats.

This is enabled by each fastener being located rearward of its respective insert wedge and actuated from the radial fastening direction Rf.

The insert holder is believed to be user-friendly while also allowing removal of cutting inserts while the insert holder is secured for machining operations. Further, the insert holder is believed to allow for a rigid tool and with a short overhang.

In accordance with a second aspect of the subject matter of the present application there is provided a rotary cutting tool comprising:
an insert holder according to the first aspect; and
a cutting insert releasably fastened to said insert holder, the cutting insert comprising opposing top and bottom insert surfaces, with an insert peripheral surface located therebetween.

In accordance with a third aspect of the subject matter of the present application there is provided an insert holder rotatable about a central axis C defining a radial direction Rd perpendicular to the central axis C and opposing forward and rearward directions Df, Dr, the insert holder comprising:
a coupling portion and a cutting portion located forwardly of the coupling portion, the cutting portion comprising:
   a forward end surface facing, and delimiting the insert holder, in the forward direction Df;
   a holder peripheral surface extending between the forward end surface and the coupling portion;
   a plurality of insert seats, each comprising a seating surface and opening out to at least one of the forward end surface and the holder peripheral surface;
   a plurality of fastener receptacles, each formed in the holder peripheral surface and communicating with a respective insert seat via a corresponding through bore; and
a plurality of insert wedges, each located at least partially in a respective insert seat and having a threaded pin extending into a corresponding through bore;
a plurality of fasteners, each occupying a respective fastener receptacle, each fastener comprising:
   a fastening axis F defining a radial fastening direction Rf perpendicular thereto, a top fastener surface, a bottom fastener surface located rearwardly of the top fastener surface along the fastening axis F, and a peripheral fastener surface located between the top and bottom fastener surfaces;
   a threaded bore extending along the fastening axis F and opening out to the top fastener surface; and
   at least one radially accessible key recess recessed into the peripheral fastener surface;
wherein:
each fastener is centered about a corresponding central fastener axis S which is coincident with that fastener's fastening axis F, and along which the threaded pin of a respective insert wedge extends; and
each fastener is configured to rotate and threadingly engage the threaded pin of its respective insert wedge, upon insertion of a key into the key recess in a direction along the radial fastening direction Rf followed by movement of the key in a predetermined circumferential fastening direction Fd about the corresponding fastening axis F.

It is understood that the above-said is a summary, and that features described hereinafter may be applicable in any combination to the subject matter of the present application, for example, any of the following features may be applicable to the cutting tool and/or the insert holder and/or the cutting insert.

Each fastener may comprise a key recess recessed therein, the key recess facing in the radial fastening direction.

Each insert wedge may be in a threaded engagement with its respective fastener; and the fastener may be actuated by rotation about the fastening axis F.

Each insert wedge may comprise a wedge head, a slanted clamping surface and a threaded pin extending rearwardly from the wedge head along the fastening axis F; and each fastener may comprise: a top fastener surface, a bottom fastener surface located rearwardly of the top fastener surface and a peripheral fastener surface located therebetween; a threaded bore opening out to the top fastener surface and engaging the insert wedge's threaded pin in a threaded connection; and at least one radially accessible key recess recessed into the peripheral fastener surface, the key recess facing in the radial fastening direction Rf.

The insert holder may further comprise: a plurality of fastener receptacles, each fastener receptacle being recessed into the holder peripheral surface rearwardly of a respective insert seat; and a plurality of through-bores, each through-bore opening out to one of the plurality of fastener receptacles and to the respective insert seat of said fastener receptacle; each threaded pin extends from its respective wedge head, through its respective through-bore and engages with the threaded bore of its respective fastener.

The insert holder may further comprise a plurality of fastener receptacles recessed into the holder peripheral surface, each fastener receptacle comprising: a forward receptacle surface delimiting the fastener receptacle in the forward direction Df, and a rearward receptacle end delimiting the fastener receptacle in the rearward direction Dr; wherein: a clamping overhang Lc, measured parallel to the central axis C from the forward end surface to the rearward end, fulfils the following condition: 15 mm≤Lc≤30 mm.

A clamping angle aa, measured between the fastening axis F and the seating surface in an edge-on side view of the seating surface, may fulfil the following condition: 15°≤aa≤45°.

In a top view of the insert holder along the central axis C, a breaching angle ba, measured between the fastening axis F and the seating surface, may fulfil the following condition: 80°≤ba≤100°.

The cutting insert may have a circular shape.

The cutting insert may be made of a ceramic material.

Each fastener may comprise a top fastener surface, a bottom fastener surface located rearwardly of the top fastener surface, a peripheral fastener surface located therebetween and at least one radially accessible key recess recessed into the peripheral fastener surface; each insert wedge may comprise a wedge head, a slanted clamping surface and a threaded pin extending rearwardly from the wedge head; and the insert top surfaces of each cutting insert may abut against the slanted clamping surface of its respective insert wedge and each of the insert bottom surfaces may abut against the seating surface of its respective insert seat.

The insert holder may further comprise a plurality of through-bores, each opening out to a fastener receptacle and its respective insert seat; each of the fastener receptacles may be recessed into the holder peripheral surface and may comprise a forward receptacle surface delimiting the fastener receptacle in the forward direction Df; each threaded pin may extend from its respective wedge head, through its respective through-bore and engage the fastener; and each fastener may be located in a respective fastener receptacle with the top fastener surface of each fastener abutting against the forward receptacle surface of its respective fastener receptacle.

### BRIEF DESCRIPTION OF THE FIGURES

For a better understanding of the present application and to show how the same may be carried out in practice, reference will now be made to the accompanying drawings, in which:

FIG. 1 is a perspective view of a cutting tool according to an aspect of the present application;

FIG. 2 is an exploded view of the cutting tool shown in FIG. 1;

FIG. 3 is a perspective view of the insert holder shown FIG. 1, devoid of the insert clamping mechanism;

FIG. 4 is an enlarged side view of the insert holder shown in FIG. 3;

FIG. 5 is a perspective view of the insert clamping mechanism and the cutting insert shown in FIG. 1;

FIG. 6 is a top view of the insert holder shown in FIG. 3;

FIG. 7 is an enlarged side view of the insert holder shown in FIG. 1, including the insert clamping mechanism;

FIG. 8 is a side view of the cutting tool shown in FIG. 1; and

FIG. 9 is a top view of the cutting tool shown in FIG. 1.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

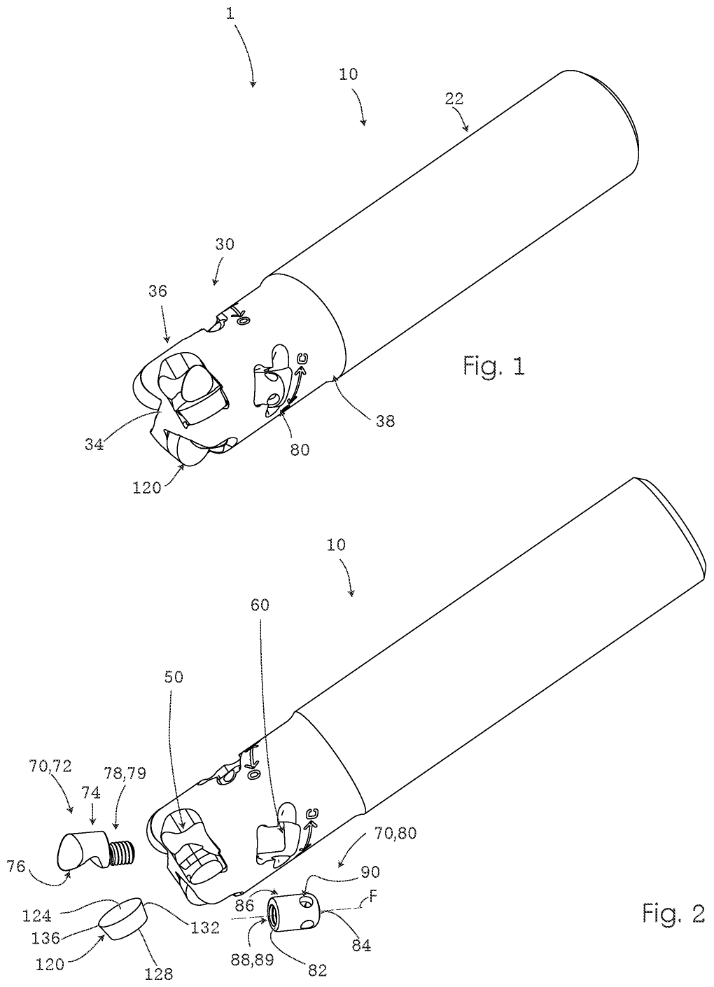

Attention is first drawn to FIGS. 1 and 2, showing a rotary cutting tool 1. The cutting tool 1 includes an insert holder 10 and a cutting insert 120 releasably fastened thereto using an insert clamping mechanism 70. The insert holder (10) seen in the figures can also be considered a “milling cutter body”.

The cutting insert 120 includes opposing top and bottom insert surfaces 124, 128, with an insert peripheral surface 132 located therebetween. A cutting edge 136 is formed at an intersection of the top insert surface 124 and the insert peripheral surface 132. In some embodiments, the cutting insert 120 may be made of a ceramic material. Alternatively, the cutting insert 120 may be made from other hard metals, for instance cemented carbide. The cutting insert 120 may be circular in shape.

On assembly of the cutting tool 1, the cutting insert 120 is placed in the insert seat 50. The fastener 80 is then actuated, bringing the insert clamping mechanism 70 into engagement with the insert top surface 124 and the insert bottom surface 128 abuts against the insert seat 50.

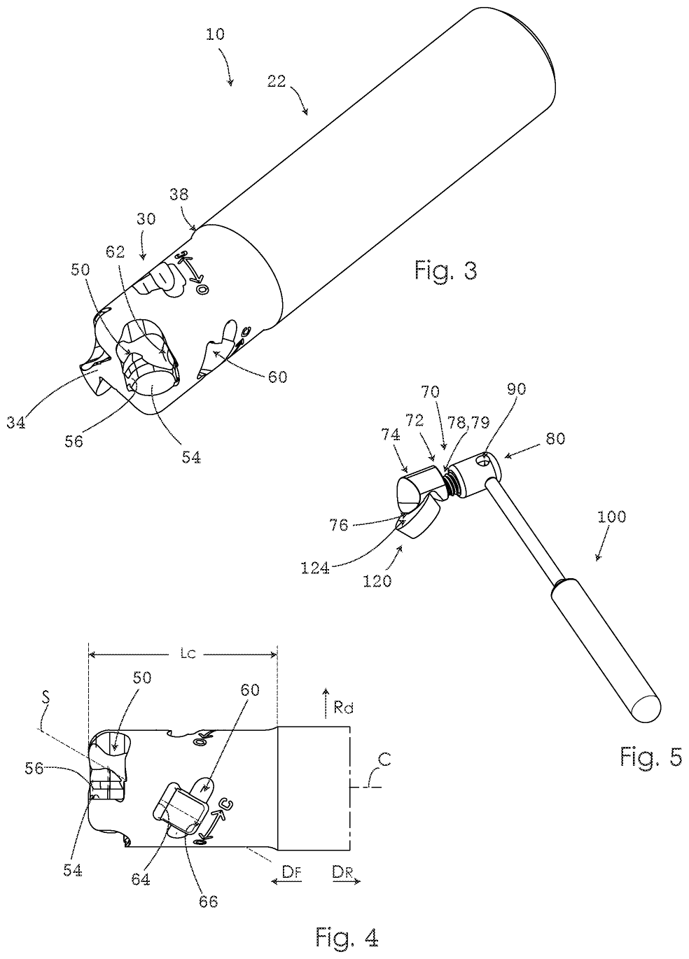

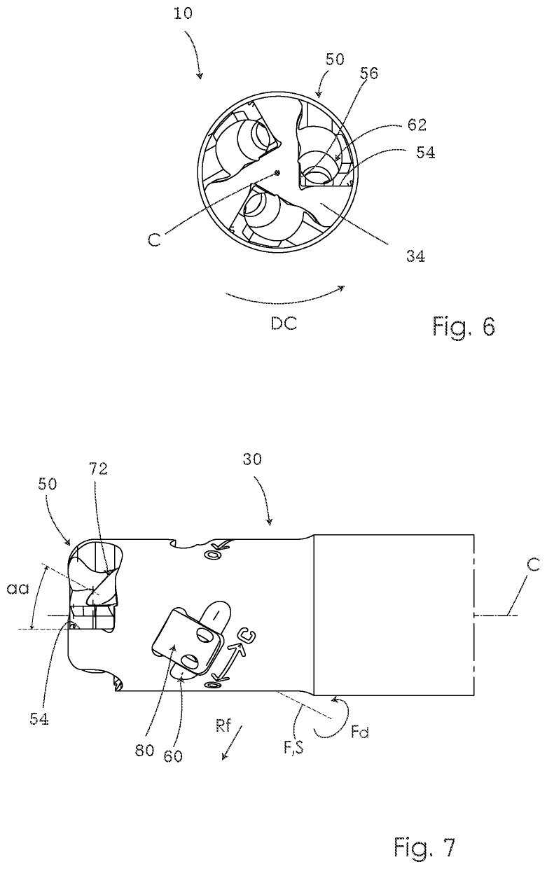

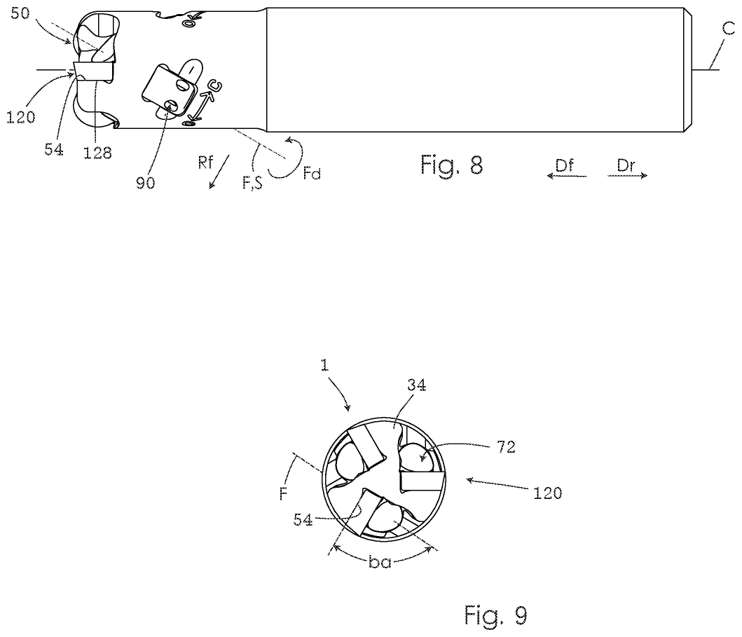

As shown in FIGS. 3 to 10, the insert holder 10 is rotatable about a central axis C. The central axis C defines a radial direction Rd perpendicular to the central axis C and opposing forward and rearward directions Df, Dr parallel to the central axis C. During machining operations, the cutting inserts 120 are fastened to the insert holder 10 and the insert holder 10 is rotated about the central axis C in the cutting direction Dc.

The insert holder 10 includes a coupling portion 22 and a cutting portion 30. The cutting portion 30 is located forwardly of (i.e. in the forward direction Df relative to) the coupling portion 22. The coupling portion 22 is used to secure the insert holder 10 during machining operations, usually the coupling portion 22 is secured to an adapter (not shown) which is then placed in a turret (not shown) during machining operations. The cutting portion 30 includes a forward end surface 34, a holder peripheral surface 36, a plurality of insert seats 50 (i.e. at least two insert seats 50) and a plurality of insert clamping mechanisms 70.

In some embodiments, the cutting portion 30 may further include a rearward end 38. The rearward end 38 delimits the cutting portion 30 in the rearward direction Dr. This may, for example, ensure repeatable overhang of the cutting tool 1.

The forward end surface 34 faces in the forward direction Df and delimits the insert holder in the forward direction Df. Differently put, the forward end surface 34 is transverse (i.e. extending across) to the central axis C. Specifically, the forward end surface 34 may be perpendicular to the central axis C.

The holder peripheral surface 36 extends between the forward end surface 34 and the coupling portion 22. Optionally, the holder peripheral surface 36 extends from the forward end surface 34 to the rearward end 38.

Each insert seat 50 of the plurality of insert seats 50 includes a seating surface 54 and opens out to at least one out of the forward end surface 34 and the holder peripheral surface 36. Preferably but optionally, the insert seat 50 opens out to both the forward end surface 34 and the holder peripheral surface 36. In some embodiments each insert seat 50 further includes a peripheral seat surface 56 transverse to the seating surface 54. Specifically, the peripheral seat surface 56 may be perpendicular to the seating surface 54. The relation between the seating surface 54 and the peripheral seat surface 56 depends mainly on the shape of the cutting insert 120.

Each insert clamping mechanism 70 of the plurality of insert clamping mechanisms 70 includes an insert wedge 72 and a fastener 80. The insert wedge 72 is located at least partially in its respective insert seat 50, while the fastener 80 occupies a respective fastener receptacle 60 (described further below).

The fastener 80 is centered about a fastening axis F defining a radial fastening direction Rf perpendicular to the fastening axis F, and also defining a circumferential fastening direction Fd about the fastening axis F (see FIG. 7). The fastener 80 is located rearwardly of a respective insert wedge 72. Further, the fastener 80 is connected to said respective insert wedge 72. Optionally, the fastener 80 is releasably engaged to the insert wedge 72, for example through a threaded connection.

The fastener 80 is engaged from the radial fastening direction Rf. For example, as shown in FIG. 5, a key 100 can actuate the insert clamping mechanism 70 (i.e. fastening or releasing the cutting insert 120 from the insert holder 10), after being aligned to the key recess 90 and moved parallel to the radial fastening direction Rf (i.e., perpendicular to the fastening axis F) until it engages the fastener 80. Once it engages the fastener 80, the key 100 is then in a position to control the fastening and/or release of the cutting insert 120, via the insert wedge 72. This ensures that replacement of the cutting inserts 120 is easy and can be achieved while the insert holder 10 remains secured to the aforementioned adapter. As explained below, this may also allow the length of the cutting portion (i.e. overhang) to be small, which is desirable in some embodiments.

Actuating the fastener 80 is facilitated by structures provided on the fastener 80 itself. For example a protrusion, a recess or a faceted surface formed on the fastener 80 may be engaged by a complementary structure formed on an actuating tool, such as a wrench, screwdriver or key. In the exemplary embodiment, a pin-shaped key 100 is used to interact with a key recess 90 formed on the fastener 80 to actuate the latter.

In some embodiments, the insert wedge 72 is in threaded engagement with the fastener 80. That is to say, one of the insert wedge 72 and the fastener 80 includes a female-threaded portion, while the other of the insert wedge 72 and the fastener 80 includes a male-threaded portion. Thus, the male-threaded and female-threaded portions, each belonging to one the insert wedge 72 and the fastener 80, engage one another in a threaded engagement. In such case, the fastener 80 is actuated by rotation about the fastening axis F. Specifically, the fastener 80 is rotated in the circumferential fastening direction Fd about the fastening axis F.

In some embodiments, such as the embodiments shown in the figures, the insert wedge 72 includes a male-threaded portion (for example a threaded pin 78) and the fastener 80 includes a female threaded portion (for example a threaded bore 88). The structure of the insert seat 50, in the embodiments shown in the figures, is open in the forward direction Df. The fastener receptacle 60, in the embodiments shown in the figures, is closed in the rearward direction Dr. Further, the fastener 80 is almost the same size as the fastener receptacle 60. The above-mentioned embodiment may enable ease of access for a male-threaded portion to be placed within the insert holder 10.

Note that it is possible that, in other embodiments (not shown), the insert wedge 72 has the female threaded portion, while the fastener 80 has the male-threaded portion.

Further, in some embodiments, the insert wedge 72 has a wedge head 74, a slanted clamping surface 76 and a threaded pin 78. The slanted clamping surface 76 faces in the radial fastening direction Rf. Further, the clamping surface 76 may be slanted relative to the fastening axis F (for example, the clamping surface 76 may be slanted such that it faces in the radial fastening direction Rf and in a direction towards the fastener 80). This may allow for better clamping of the cutting insert 120 in the insert seat 50. In some embodiments, the wedge head 74 comprises the slanted clamping surface 76. The slanted clamping surface 76 may be integrally formed with the wedge head 74.

The threaded pin 78 of the insert wedge 72 extends rearwardly from the wedge head 74 along the fastening axis F. Preferably but optionally, the threaded pin 78 is centered about the fastening axis F. The threaded pin 78 has at least one thread 79 extending along its length. Specifically, there may be a plurality of such threads 79. Further, at least a portion of the threaded pin 78 may be devoid of any threads 79.

As mentioned above, on assembly of the cutting tool 1 the fastener 80 is actuated, releasably securing the cutting insert 120 to the insert holder 10. Specifically, the slanted clamping surface 76 of the fastener's respective insert wedge 72 abuts against the insert top surface 124 of the corresponding cutting insert 120. Meanwhile, the bottom insert surface 128 of the corresponding cutting insert 120 abuts against the seating surface 54 of its respective insert seat 50.

In some embodiments, the fastener 80 has a top fastener surface 82, a bottom fastener surface 84, a peripheral fastener surface 86, a threaded bore 88 and at least one radially accessible key recess 90. Within a fastener receptacle, the fastener 80 is rotatable about a central fastener axis S.

The top and bottom fastener surfaces 82, 84 oppose one another, with the bottom fastener surface 84 being located rearwardly of the top fastener surface 82 along the fastening axis F. The peripheral fastener surface 86 is located between the top and bottom fastener surfaces 82, 84, with the key recess 90 being recessed into the peripheral fastener surface 86.

The threaded bore 88 opens out to the top fastener surface 82. The threaded bore 88 may also open out to the bottom fastener surface 84.

The threaded bore 88 has at least one bore thread 89 extending along its length. The bore thread 89 of the threaded bore 88 and the thread 79 of the threaded pin 78 engage one another, with the threaded pin 78 fastened to the threaded bore 88. In some embodiments, the at least one key recess 90 is located closer to the bottom fastener surface 84 than to the top fastener surface 82.

And as seen in FIG. 7, when the fastener 80 occupies a fastener recess 60, the central fastener axis S can be coincident with the fastening axis F.

As seen in the figures, the key recess 90 faces in the radial fastening direction Rf. This ensures that the key 100, as discussed above, is able to actuate the insert clamping mechanism 70, through engagement with the key recess 90. More particularly, first, the key 100 is oriented to align with the key recess 90, and then the key 100 is urged into the key recess 90. Only after first being moved in a direction parallel to the radial fastening direction Rf (i.e. perpendicular to the fastening axis F), is the key 100 moved in the circumferential fastening direction Fd. In some embodiments, the key 100 is moved only in the radial fastening direction Rf to be urged into the key recess 90. In other embodiments, the key 100 may need to be moved in an additional direction, for example along the fastening axis F, to be urged into the key recess 90.

In some embodiments, the insert holder 10 further includes a plurality of fastener receptacles 60 and a plurality of through-bores 62. Each fastener receptacle 60 of the plurality of fastener receptacles 60 is recessed into the holder peripheral surface 36 and is located rearwardly of a respective insert seat 50. Optionally, each fastener receptacle 60 is located rearwardly of the plurality of insert seats 50.

Each through-bore 62 opens out to one fastener receptacle 60 as well as to its respective insert seat 50. Thus, the through-bore 62 connects the fastener receptacle 60 and its respective insert seat 50. Optionally, the through-bore 62 is devoid of any threading.

Each threaded pin 78 extends from its respective wedge head 74, which is located at its respective insert seat 50, through the respective through-bore 62 and into the respective fastener receptacle 60. The threaded pin 78 engages with the threaded bore 88 of its respective fastener 80.

Each fastener receptacle 60 may include a forward receptacle surface 64 and a rearward receptacle end 66 (see FIG. 4). The forward receptacle surface 64 delimits the fastener receptacle 60 in the forward direction Df. The rearward receptacle end 66 delimits the fastener receptacle 60 in the rearward direction Dr.

Preferably but optionally, the top fastener surface 82 of each of the fastener 80 abuts against the forward receptacle surface 64 of its respective fastener receptacle 60. Further, the bottom fastener surface 84 may be distanced away from the rearward receptacle end 66.

In some embodiments, a clamping overhang Lc is measured parallel to the central axis C from the forward end surface 34 to the cutting portion's rearward end 38. The clamping overhang Lc fulfils the following condition: 15 mm≤Lc≤30 mm. Specifically, the clamping overhang Lc may fulfil the following condition: 20 mm≤Lc≤28 mm. The clamping overhang Lc may further fulfil the following condition: 23 mm≤Lc≤27 mm. Smaller clamping overhang Lc is desirable as it may, for example, improve the surface quality of the workpiece during machining operations. This may be attributed to, for example, less vibrations.

Note that the minimal values of the clamping overhang Lc are dependent on the rearward receptacle end 66. The cutting portion's rearward end 38, which defined the clamping overhang Lc, must necessarily be located rearwardly of the rearward receptacle end 66. Thus, the rearward receptacle end 66 delimits the minimal value of clamping overhang Lc. The fastener receptacle 60 may, in some embodiments, have minimal length along the fastening axis F. This may allow the rearward end 38 to be located more forwardly.

In some embodiments, a clamping angle aa is measured between the fastening axis F of a given fastener 80 and the seating surface 54 of its respective insert seat 50, in an edge-on side view of the seating surface (as seen in FIG. 7). The side view shown in FIG. 7 is perpendicular to the seating surface 54 of the insert seat 50 and parallel to the central axis C. The clamping angle aa fulfils the following condition: 15°≤aa≤45°. Specifically, the clamping angle aa may fulfil the following condition: 20°≤aa≤40°. The clamping angle aa may further fulfil the following condition: 25°≤aa≤35°. The above-mentioned angle ranges have been found advantageous in numerous ways. For instance, such ranges advantageously balance axial (i.e. parallel to the central axis C) and circumferential (i.e. parallel to the cutting direction Dc) clamping forces securing the cutting inserts 120. Similarly, the clamping angle aa may also affect the clamping overhang Lc and the number of insert seats 50 which can be placed within the insert holder 10.

In some embodiments, in a top view of the insert holder (as seen in FIG. 9), a breaching angle ba is measured between the fastening axis F of a given fastener 80 and the seating surface 54 of its respective insert seat 50. The top view shown in FIG. 9 is perpendicular to the central axis C. The breaching angle ba fulfils the following condition: 80°≤ba≤100°. Specifically, the breaching angle ba may fulfil the following condition: 85°≤ba≤95°. The breaching angle ba may further fulfil the following condition: 88°≤ba≤92°. The above angle ranges were found to be advantageous. For instance, a different breaching angle ba may adversely affect the clamping forces securing the cutting inserts 120. Similarly, a different breaching angle ba may compromise the integrity of the insert holder 10, due to removal of material therein. This may, in turn, lead to adverse cutting conditions such as vibrations.

Although the subject matter of the present application has been described to a certain degree of particularity, it should be understood that various alterations and modifications could be made without departing from the spirit or scope of the invention as hereinafter claimed.

What is claimed is:

1. An insert holder (10) rotatable about a central axis (C) defining a radial direction (Rd) perpendicular to the central axis (C) and opposing forward and rearward directions (Df, Dr), the insert holder (10) comprising:
a coupling portion (22) and a cutting portion (30) located forwardly of the coupling portion (22), the cutting portion (30) comprising:
a forward end surface (34) facing, and delimiting the insert holder (10), in the forward direction (Df);
a holder peripheral surface (36) extending between the forward end surface (34) and the coupling portion (22);
a plurality of insert seats (50), each comprising a seating surface (54) and opening out to at least one of the forward end surface (34) and the holder peripheral surface (36);
a plurality of insert wedges (72), each located at least partially in a respective insert seat (50); and
a plurality of fasteners (80), each located rearwardly of, and coupled to, a respective insert wedge (72);
wherein:
each fastener (80) is centered about a corresponding fastening axis (F) and its respective insert wedge (72) extends along the corresponding fastening axis (F); and
each fastener (80) is configured to be actuated from a radial fastening direction (Rf) perpendicular to the corresponding fastening axis (F).

2. The insert holder (10) according to claim 1, wherein:
each fastener (80) comprises a key recess (90) recessed therein, the key recess (90) facing in the radial fastening direction (Rf).

3. The insert holder (10) according to claim 1, wherein:
each insert wedge (72) is in a threaded engagement with its respective fastener (80); and
each fastener (80) is actuated by rotation about the fastening axis (F).

4. The insert holder (10) according to claim 3, wherein:
each insert wedge (72) comprises a wedge head (74), a slanted clamping surface (76) and a threaded pin (78) extending rearwardly from the wedge head (74) along the fastening axis (F); and
each fastener (80) comprises:
a top fastener surface (82), a bottom fastener surface (84) located rearwardly of the top fastener surface (82) and a peripheral fastener surface (86) located therebetween;
a threaded bore (88) opening out to the top fastener surface (82) and engaging the insert wedge's threaded pin (78) in a threaded connection; and
at least one radially accessible key recess (90) recessed into the peripheral fastener surface (86), the key recess (90) facing in the radial fastening direction (Rf).

5. The insert holder (10) according to claim 4, wherein:
the insert holder (10) further comprises:
a plurality of fastener receptacles (60), each fastener receptacle (60) being recessed into the holder peripheral surface (36) rearwardly of a respective insert seat (50); and
a plurality of through-bores (62), each through-bore (62) opening out to one of the plurality of fastener receptacles (60) and to the respective insert seat (50) of said fastener receptacle (60);
each threaded pin (78) extends from its respective wedge head (74), through its respective through-bore (62) and engages with the threaded bore (88) of its respective fastener (80).

6. The insert holder (10) according to claim 1, further comprising a plurality of fastener receptacles (60) recessed into the holder peripheral surface (36), each fastener receptacle (60) comprising:
a forward receptacle surface (64) delimiting the fastener receptacle (60) in the forward direction (Df); and
a rearward receptacle end (66) delimiting the fastener receptacle (60) in the rearward direction (Dr);
wherein:
a clamping overhang Lc, measured parallel to the central axis (C) from the forward end surface (34) to the rearward end (38), fulfils the following condition: 15 mm≤Lc≤30 mm.

7. The insert holder (10) according to claim 1, wherein:
a clamping angle aa, measured between the fastening axis (F) and the seating surface (54) in an edge-on side view of the seating surface (54), fulfils the following condition: 15°≤aa≤45°.

8. The insert holder (10) according to claim 1, wherein:
in a top view of the insert holder (10) along the central axis (C), a breaching angle ba, measured between the fastening axis (F) and the seating surface (54), fulfils the following condition: 80°≤ba≤100°.

9. A rotary cutting tool (1) comprising:
the insert holder (10) according to claim 1; and
a cutting insert (120) releasably fastened to said insert holder (10), the cutting insert (120) comprising opposing top and bottom insert surfaces (124, 128), with an insert peripheral surface (132) located therebetween.

10. The rotary cutting tool (1) according to claim 9, wherein:
the cutting insert (120) has a circular shape.

11. The rotary cutting tool (1) according to claim 1, wherein:
the cutting insert (120) is made of a ceramic material.

12. The rotary cutting tool (1) according to claim 9, wherein:
each fastener (80) comprises a top fastener surface (82), a bottom fastener surface (84) located rearwardly of the top fastener surface (82), a peripheral fastener surface (86) located therebetween and at least one radially accessible key recess (90) recessed into the peripheral fastener surface (86);
each insert wedge (72) comprises a wedge head (74), a slanted clamping surface (76) and a threaded pin (78) extending rearwardly from the wedge head (74); and
the insert top surfaces (124) of each cutting insert (120) abuts against the slanted clamping surface (76) of its respective insert wedge (72) and each of the insert bottom surfaces (128) abuts against the seating surface (54) of its respective insert seat (50).

13. The rotary cutting tool (1) according to claim 12, wherein:
the insert holder (10) further comprises a plurality of through-bores (62), each opening out to a fastener receptacle (60) and its respective insert seat (50);
each of the fastener receptacles (60) is recessed into the holder peripheral surface (36) and comprises a forward receptacle surface (64) delimiting the fastener receptacle (60) in the forward direction (Df);
each threaded pin (78) extends from its respective wedge head (74), through its respective through-bore (62) and engages the fastener (80); and
each fastener (80) is located in a respective fastener receptacle (60) with the top fastener surface (82) of each fastener (80) abutting against the forward receptacle surface (64) of its respective fastener receptacle (60).

14. An insert holder (10) rotatable about a central axis (C) defining a radial direction (Rd) perpendicular to the central axis (C) and opposing forward and rearward directions (Df, Dr), the insert holder (10) comprising:
a coupling portion (22) and a cutting portion (30) located forwardly of the coupling portion (22), the cutting portion (30) comprising:
a forward end surface (34) facing, and delimiting the insert holder (10), in the forward direction (Df);
a holder peripheral surface (36) extending between the forward end surface (34) and the coupling portion (22);
a plurality of insert seats (50), each comprising a seating surface (54) and opening out to at least one of the forward end surface (34) and the holder peripheral surface (36);
a plurality of fastener receptacles (60), each formed in the holder peripheral surface (36), having a central fastener axis (S) and communicating with a respective insert seat (50) via a corresponding through bore (62); and
a plurality of insert wedges (72), each located at least partially in a respective insert seat (50) and having a threaded pin (78) extending into a corresponding through bore (62);
a plurality of fasteners (80), each occupying a respective fastener receptacle (60), each fastener (80) comprising:
a fastening axis (F) defining a radial fastening direction (Rf) perpendicular thereto, a top fastener surface (82), a bottom fastener surface (84) located rearwardly of the top fastener surface (82) along the fastening axis (F), and a peripheral fastener surface (86) located between the top and bottom fastener surfaces (82, 84);
a threaded bore (88) extending along the fastening axis (F) and opening out to the top fastener surface (82); and
at least one radially accessible key recess (90) recessed into the peripheral fastener surface (86);
wherein:
the central fastener axis (S) of each fastener receptacle (60) is coincident with its respective fastener's fastening axis (F), and along which the threaded pin (78) of a respective insert wedge (72) extends; and
each fastener (80) is configured to rotate and threadingly engage the threaded pin (78) of its respective insert wedge (72), upon insertion of a key (100) into the key recess (90) in a direction along the radial fastening direction (Rf) followed by movement of the key (100) in a predetermined circumferential fastening direction (Fd) about the corresponding fastening axis (F).
